(19) United States
(12) Patent Application Publication
(10) Pub. No.: US 2003/0112929 A1
(43) Pub. Date: Jun. 19, 2003

(54) Video phone system having function of answering machine

(76) Inventor: Kevin Chuang, Taipei Hsien (TW)

Correspondence Address: J.C. Patents, Inc., Suite 250, 4 Venture, Irvine, CA, 92618, US

(21) Appl. No.: 10/026,062

(22) Filed: Dec. 19, 2001

(51) Int. Cl. H04M 11/00

(52) U.S. Cl. 379/88.13

(57) ABSTRACT

A video phone system with an answering machine function. While receiving a phone call, a conversation is established if an operator is available, if no one answers the call, an audiovisual answering system is initiated. This answering system stores the audio message or the audiovisual message according to the system used by the calling party. A user has to input a password to retrieve the messages. In addition, the owner of the video phone system can combine audio-visual information with a graph to configure the incoming call instructions.

### BACKGROUND OF THE INVENTION

1. Field of the Invention

The invention relates in general to a video phone system, and more particularly, to a video phone system with an answering machine function.

2. Description of the Related Art

Currently, none of the video phones have an answering machine function, so that the user of the video phone could leave a message when there is no one to answer the phone call. This is very inconvenient for both the users and the callers.

### SUMMARY OF THE INVENTION

The present invention provides a video phone system that has an answering machine function, such that video and audio information can be stored in the video phone for further integration and play. The user can thus obtain the function of the video phone answering machine to record and store both video and audio.

In the invention, whether an incoming call is received is determined. If the incoming call is answered by the user, a conversation is established. If the incoming call is not answered by the user, the answering mode is entered after a predetermined buffering time. The video phone with answering machine function confirms the type of the system used by the calling party. If the system used by the calling party is an audio system, an audio instruction is played to allow the caller to access an audio message by inputting a password. When the specific password required is not input, the system plays an instruction allowing the caller to leave a message after a beep. If the duration of the audio message exceeds a message cutoff time, the incoming call is terminated. If the caller inputs the correct password, the system plays an instruction to allow the caller to listen to the recorded messages. If the incoming call is hung up, or the caller finishes listening to the recorded messages, the incoming call is terminated.

If the calling party uses a video system, an audiovisual instruction is played to request the caller to input the password. If the specific password required by the system is not input, the system plays an instruction to request the caller to leave a message after a beep. If the duration of the audiovisual message exceeds a message cutoff time, the incoming call is terminated. If the caller inputs the correct password, the system provides an audiovisual abstract for the caller to listen to the recorded messages. If the incoming call is hung up, or the caller finishes listening to the recorded message, the incoming call is terminated.

The present invention further provides a video phone with an answering function, including a phone interface, a host controller, a caller message recording apparatus and a host instruction recording apparatus. The phone interface is coupled to a telephone line to convert an audio or audiovisual signal transmitted via the telephone line into audio data or a second audiovisual data accessible to the video phone. The host controller is coupled to the phone interface to record the audio data and the audiovisual data. The caller message recording apparatus is coupled to the host controller to record the message. The host instruction recording apparatus is coupled to the host controller to record the instruction for the incoming call.

In one embodiment of the present invention, the video phone can be connected to an external digital audiovisual recording apparatus via the host controller for audio or audiovisual data storage. The caller message recording apparatus and the host instruction recording apparatus include Compact Flash (CF) recording apparatus, memory stick (MS) recording apparatus, secure digital memory card (SD) recording apparatus, or a tape recording apparatus.

According to the above, the present invention uses the phone interface, the host controller, the caller message recording apparatus and the host instruction recording apparatus to expand the video phone into a video phone with an answering machine function. The video and audio data are then integrated, such that a video phone with the answering machine function can be obtained.

Both the foregoing general description and the following detailed description are exemplary and explanatory only and are not restrictive of the invention, as claimed.

### BRIEF DESCRIPTION OF THE DRAWINGS

FIG. 1 shows a system flow chart of a video phone with an answering function according to the present invention;

FIG. 2 shows the process flow for message recording in the system flow chart of the video phone as shown in FIG. 1; and

FIG. 3 shows a block diagram of the circuit of the video phone with the answering machine function.

### DESCRIPTION OF THE PREFERRED EMBODIMENTS

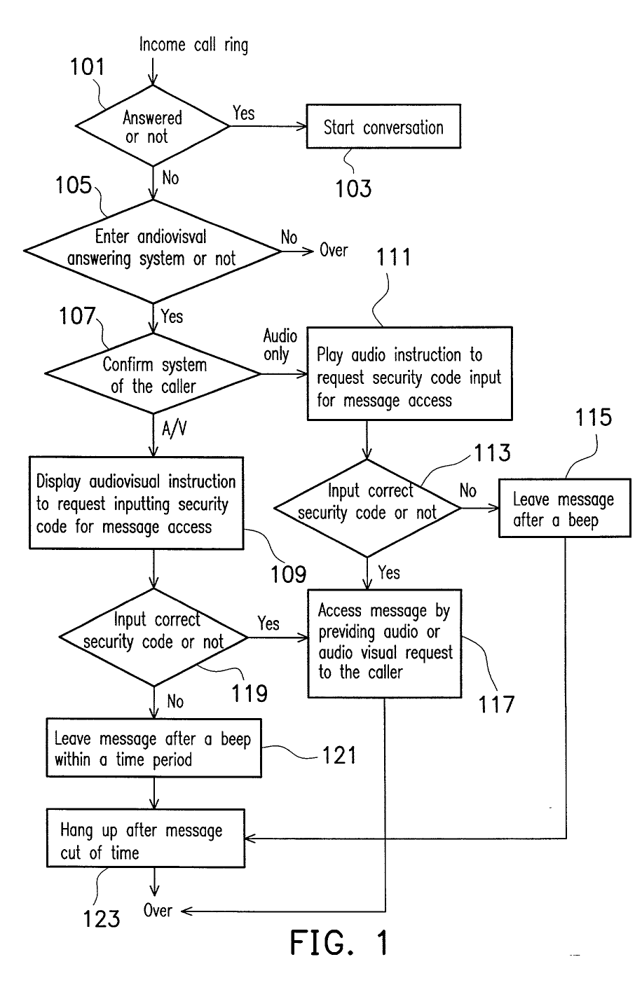

Referring to FIG. 1, a system flow chart for a video phone having answering machine function is shown. When an incoming call made by a caller is ringing, the system has to confirm whether the incoming call is answered or not in step 101. If the phone call is received, a conversation between the caller and the receiver is established in step 103. If the incoming call is not answered by the receiver, the video phone with the answering machine function enters a message recording stage after a buffering time in step 105. In step 107, the system used by the caller is determined. If the system of the caller is an audio system, an audio instruction is played requesting the caller to input the password for listening to the messages in step 111. In step 113, whether the correct password is input or not is confirmed. When the user fails to input the correct password, an audio instruction is played to instruct the caller to leave a message after a beep, and to dial the end message key after leaving the message. In step 123, if the duration of the audio message exceeds the message cutoff time, or the incoming call is hung up, the system is turned off.

When the caller inputs the correct password, the system provides the message abstract including serial number, calling time, calling number and format (audio or audiovisual) of the incoming call in step 117 for the user to listen to the messages. The incoming call is terminated after listening to the messages. If the system of the caller is an audiovisual system, the system plays an instruction to request the user to input the password for listening to the messages. In step 119, whether the correct password is input or not is confirmed. If the correct password is not input, the system provides an instruction to the caller to leave a message after a beep in step 121. Again, in step 123, when the duration of the audiovisual message exceeds the message cutoff time or when the incoming call is hung up, the system is turned off.

If the caller inputs the correct password, in step 117, the system provides an audiovisual abstract including the serial number, calling time, caller number and the format of the incoming calls (audio or audiovisual) to the caller to listen to the audiovisual or audio messages. If the incoming call is hung up, the system is turned off.

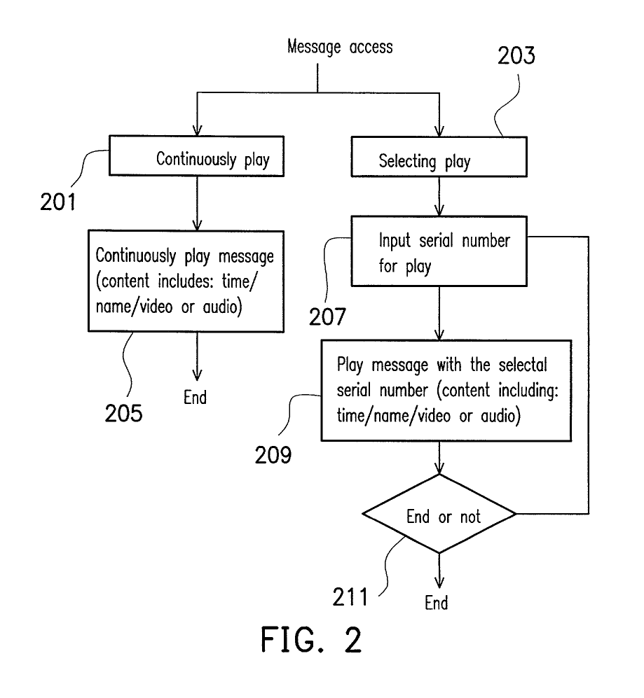

The message access part in step 117 is referred to FIG. 2. In FIG. 2, the message access includes two play modes, that is, continuous play as step 201 and selective play as step 203. When the continuous play in step 201 is selected, the system continuously plays all the messages, the contents of which comprise calling time, message format (audio or audiovisual) and the information of the message. After listening to the messages, the system is turned off. When step 203 is selected, the system requests the caller to enter the serial number of the required message according to the serial number in the abstract provided by the system. In step 209, the system enquires of the caller whether the caller wishes to terminate the operation. If not, the process jumps to step 207. If yes, the process is terminated.

In the above embodiment, the audio instruction or the audiovisual instruction is built up by the host of the system. It is appreciated that people of ordinary skill in the art may combine the audio instruction and the audiovisual instruction to display speech, image and picture.

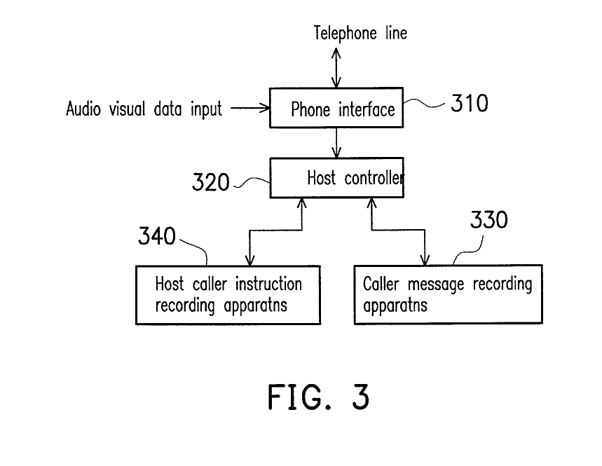

The invention further provides a video phone with an answering machine function. In FIG. 3, the video phone comprises a phone interface 310, a host controller 320, a host instruction recording apparatus 340 and a caller message recording apparatus 330. The video phone pre-records the caller instruction via the phone interface 310 and stores the caller instruction in the host instruction recording apparatus 340 via the host controller 320. An example of the contents of the instruction is shown as table 1.

TABLE 1

| | | | | |
|---|---|---|---|---|
| Serial No. | Name | Phone | Instruction Format | Message |
| | | Number/ | (Audio or Audiovisual) | |
| | | Group | | |

When a caller makes an incoming call via the telephone line without being answered, the answering system is entered. After entering the answering system, the host controller 310 determines the system of the caller (audio or audiovisual), so as to determine whether the signals following are audio or audiovisual. The caller number is compared to the number contained in the instruction stored in the host instruction recording apparatus 340, and the caller instruction is provided to the caller via the phone interface 310 and the telephone line. The host controller 320 requests the user to input the password for listening to the messages stored in the caller message recording apparatus 330. The host controller 320 determines whether the password input by the caller via the phone interface through the telephone line is correct or not. If the correct password is not input, the caller may leave a message after a beep, and then dial the end key to terminate the incoming call. The host controller 320 can then hang up or terminate the call accordingly.

If the password is correct, the message to be accessed may contain the contents as listed in Table 2. For the message access, the host controller 320 provides continuous play or selective play. If the continuous play is selected, the host controller 320 continuously plays the messages stored in the caller message recording apparatus sequentially according to the serial number. When all the messages are played or the phone is hung up, the system is turned off. If the selective play is chosen, the host controller 320 allows the caller to listen the message of the selected serial number stored in the caller message recording apparatus 330. After playing the message, the host controller 320 enquires of the user whether another message is to be listened to. If not, the call is terminated. The host controller 320 may also terminate the system by the hang-up action.

TABLE 2

| | | | |
|---|---|---|---|
| Name | Phone No. | Message Format | Message |
| | | (Audio or Audiovisual) | |

The caller message recording apparatus 330 and the host instruction recording apparatus 340 include non-volatile memory such as CompactFlash memory, memory stick card (MS), secure digital memory card (SD) or tape recording apparatus. The synchronous recording equipment such as digital recording apparatus can also be applied as a part of the recording apparatus via the phone interface.

According to the above, the present invention expands the video phone into one with an answering machine function by incorporating the display, message recording apparatus, play apparatus, recording apparatus, automatic transmission apparatus, central processing unit, and function selection apparatus. The audio and video information is integrated and applied to an answering system to enable it to process the audiovisual message. The practicability of the video phone is thus enhanced.

Other embodiments of the invention will appear to those skilled in the art from consideration of the specification and practice of the invention disclosed herein. It is intended that the specification and examples be considered as exemplary only, with a true scope and spirit of the invention being indicated by the following claims.

What is claimed is:

1. A method to provide an answering machine function to a video phone system, comprising:
determining whether an incoming call made by a caller is received by a receiver or not;
establishing a conversation between the caller and the receiver when the incoming call is received by the receiver;
initiating an answering system after a buffering time if the incoming call is not answered;
determining a system used by the caller;
if an audio system is used by the caller, playing an audio instruction to request the caller to input a password for access to an audio message stored in the video phone;
if the caller does not input the password, instructing the caller to leave an audio message, and if a duration of the audio message exceeds a message cutoff time, hanging up the incoming call;
if the password is input and confirmed, playing an audio message abstract to the caller for access to the audio messages, and when the messages have been listened to, the step of access to the audio messages is terminated;
if an audiovisual system is used by the caller, playing an audiovisual instruction to request the caller to input a password for access to audiovisual messages stored in the video phone;
if the caller does not input the password, instructing the caller to leave an audiovisual message, and if a duration of the audiovisual message exceeds a message cutoff time, hanging up the incoming call; and
if the password is input and confirmed, playing an audiovisual message abstract to the caller for access to the audiovisual message, and when the messages have been listened to, the step of access to the audiovisual messages is terminated.

2. The method according to claim 1, further comprising:
transmitting the audio message and the audiovisual message to a personal computer or a video phone after access to the audio message or audiovisual message is terminated.

3. The method according to claim 1, wherein the audio message and the audiovisual message are pre-recorded before the incoming call is made.

4. The method according to claim 1, wherein the step of access to the audio message and the audiovisual message further comprises:
selecting either a continuous play or a selective play, wherein:
if the continuous play is selected, either the audio or the audiovisual message stored in the video phone is continuously played; and
if the selective play is selected, either the audio or the audiovisual message with a selected serial number stored in the video phone is played.

5. The method according to claim 1, wherein the audio message abstract comprises a message time, a message format and a recording length.

6. The method according to claim 1, wherein the audiovisual message abstract comprises a message time, a message format and a recording length.

7. The method according to claim 4, wherein when the audio message is played, the audio message comprises a calling time, a caller number and audio information; and when the audiovisual message is played, the audiovisual message comprises a calling time, a caller number and audio information.

8. A video phone with answering machine function, comprising:
a phone interface, coupled to a telephone line to receive audiovisual information, and to select and convert an audio signal and an audiovisual signal to audio data and audiovisual data accessible to the video phone;
a host controller, coupled to the phone interface to access the audio data and the audiovisual data;
a caller message recording apparatus, coupled to the host apparatus to record a caller message; and
a host instruction recording apparatus, coupled to the host controller to record a caller instruction.

9. The video phone according to claim 8, wherein the caller message recording apparatus comprises a non-volatile memory.

10. The video phone according to claim 9, wherein the non-volatile memory comprises a CompactFlash memory.

11. The video phone according to claim 9, wherein the non-volatile memory comprises a memory stick card.

12. The video phone according to claim 9, wherein the non-volatile memory comprises a secure digital memory card.

13. The video phone according to claim 8, further comprisinga digital audiovisual recording apparatus, coupled to the phone interface.

14. The video phone according to claim 8, wherein the caller instruction comprises a name column, a group column, an instruction data format column and instruction speech data.

15. The video phone according to claim 8, wherein the caller instruction is built up by a user of the video phone.

16. The video phone according to claim 15, wherein the caller message is made according to the caller instruction to include a name column, a caller message format column, a calling number, a calling time and calling message data.
